(19) United States
(12) Patent Application Publication
(10) Pub. No.: US 2024/0305101 A1
(43) Pub. Date: Sep. 12, 2024

(54) SYSTEMS AND METHODS FOR PARALLELING MULTIPLE POWER SOURCES

(71) Applicant: Cummins Power Generation Inc., Minneapolis, MN (US)

(72) Inventors: Robert Charles Borregard, Charleston, SC (US); Michael James Scheuerell, Stillwater, MN (US); Dale Joseph Frolik, Osceola, WI (US); Andrew Novak, Minneapolis, MN (US)

(73) Assignee: Cummins Power Generation Inc., Minneapolis, MN (US)

(21) Appl. No.: 18/120,079

(22) Filed: Mar. 10, 2023

(51) Int. Cl. H02J 3/32; H02J 3/00

(52) U.S. Cl. CPC H02J 3/32; H02J 3/001; G05B 2219/2639

(57) ABSTRACT

Systems and methods for managing loads on a power grid are provided. In some embodiments, the load control system includes one or more power sources connected to a power grid. A method includes determining, by a first genset connected to a power grid, a power average at a first rate, and generating, by the first genset, a filtered power average. The filtered average includes the power average at a second rate. The filtered power average is used in a second algorithm to balance the load share of power sources on the power grid.

### TECHNICAL FIELD

The present disclosure relates generally to electric power transmission. More particularly, the present disclosure relates to systems and methods for controlling power on a power grid.

### BACKGROUND

On a power or utility grid, there may be one or more sources of energy (e.g., generators, wind turbines, gas turbines, steam turbines) that are designed to supply power to one or more loads. For example, a grid (e.g., micro-grid, utility grid, etc.) may include two or more generators in parallel to three or more loads. However, micro-grids are often difficult to setup and maintain, require a specialized skillset, and considerable time to deploy.

### SUMMARY

One implementation is related to a method, the method includes determining whether a grid forming power source is present, assigning a lead inverter among a plurality of inverters, wherein the lead inverter comprises a lead controller, determining, by the lead controller, a power target to achieve a power objective based on information received from the grid forming power source, and causing the power target to be implemented in the plurality of inverters.

Another implementation is related to a power generation system. The power generation system includes a first battery coupled to a first inverter among a plurality of inverters, the first inverter comprising a lead controller. The power generation system includes a second battery coupled to a second inverter among the plurality of inverters, the second inverter comprising a follower controller. The lead controller is configured to: determine that a grid forming power source is present, determine a power target to achieve a power objective based on information received from the grid forming power source; and transmit, via a network, the power target to the second inverter.

Yet another implementation is related to another power generation system. The power generation system includes a first energy storage system coupled to a power grid and comprising a first controller. The power generation system also includes a second energy storage system coupled to the power grid and comprising a second controller. The first controller and the second controller are independently configured to: determine voltage and frequency measurements of their respective energy storage systems, determine that the power generation system is experiencing a transient event based on the voltage and frequency measurements, and adjust the frequency and voltage of the output power of their respective energy storage systems to manage the transient event without tripping the power generation system.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block diagram illustrating a first embodiment of a power generation system according to an exemplary embodiment.

FIG. 2 is a block diagram illustrating a second embodiment of the power generation system according to an exemplary embodiment.

FIG. 3 is a block diagram illustrating a third embodiment of the power generation system according to an exemplary embodiment.

FIG. 4 is a flow diagram of a first method for controlling power in the power generation system according to an exemplary embodiment.

FIG. 5 is a flow diagram of a first method of controlling power in the power generation system according to an exemplary embodiment.

FIG. 6 is a diagram of filtering power averages of a power source according to constraints of a network according to an exemplary embodiment.

FIG. 7 is a droop diagram of an ESS according to an exemplary embodiment.

FIG. 8 depicts a droop curve of an ESS according to a first objective is shown according to an exemplary embodiment.

FIG. 9 depicts a droop curve of an ESS according to a second objective is shown according to an exemplary embodiment.

FIG. 10 is a flow diagram of a method of voltage and hertz (V/Hz) control of an ESS according to an exemplary embodiment.

FIG. 11 is a flow diagram of a method an ESS power save mode according to an exemplary embodiment.

FIG. 12 is a graph of a droop curve of a one-way power source according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for controlling power on a power grid is provided according to exemplary embodiments. A power generation system includes one or more power sources connected to one or more inverters which may each include a controller. In some embodiments, each of the controllers may either be designated as a “lead controller” or a “follower controller.” The lead controller may be configured to determine a power target to achieve a power objective for the power generation system and communicate the power target to the follower controllers to cause the power target to be implemented in each of the power sources included in the power generation system.

The one or more inverters may be connected to a power bus which can provide power to a power grid. The power generation system may also be connected to one or more loads. In some embodiments, the power generation system may be coupled to a grid-forming power source (e.g., a grid forming generator set, etc.). In such an embodiment, the lead controller may receive the power target from the grid-forming power source. In other embodiments, the power generation system may not be connected to the grid-forming power source. In such a case, one of the inverters may be designated as the grid former. The lead controller associated with the grid-forming inverter may then be configured to determine the power target independently based on the one or more current conditions of the power generation system as detected by the inverter. In some embodiments, the power target can be communicated to the follower controllers which implement the power target.

In some embodiments, the power sources may include generator sets (“gensets”, including, for example, a combination of an engine and an alternator), energy storage systems (ESSs) such as batteries, one-way power sources (e.g., solar power sources, wind power sources), and/or other types of power sources. In some embodiments, the system may include multiple power sources connected in parallel to the power grid. In order to ensure that the power output at each genset is balanced with the other gensets, the gensets may communicate with one another. However, the bandwidth of some networks may limit the ability for the multiple power sources to communicate with an update rate sufficient enough to both maintain stability of the electrical parameters on the power grid and balance the load shared by each power source in real-time.

Accordingly, to conserve bandwidth, a load share control algorithm of each power source may be slowed down and attenuated. In this way, each power source may be configured to react, via a first algorithm, at a first rate (e.g., 50 Hz) for adjusting respective power outputs in response to electrical parameters deviating from nominal values in an attempt to maintain grid stability, and each power source may be configured to react or adjust a respective power output, via the load share control algorithm, toward a nominally-balanced steady state at a second rate (e.g., 1 Hz). In this way, transient events are effectively handled open-loop (e.g., via each power source reacting with minimal influence from the conditions of the other power sources) and the load share control algorithm is configured to drive the system toward a nominally-balanced steady state at the second rate.

For example, in an embodiment, a load share control algorithm of a first genset may be slowed down or attenuated to the second rate (e.g., 1 Hz). The first genset may be configured to update or recalculate a power average at a first rate (e.g., 50 Hz). The power average at the first rate and detected electrical parameters on the grid (e.g., frequency and voltage) may be used by the first genset in a first algorithm in an attempt to keep the electrical parameters sensed on the power grid at or near nominal values (e.g., 60 Hz and/or 120 Vrms). The first genset may filter the power average (e.g., updated at 50 Hz) via a low-pass filter having a cutoff frequency at one half of the second rate in order to generate a filtered power average. The filtered power average may then be used in the load share control algorithm (e.g., along with other filtered power averages received from other power sources and at the second rate) in order to adjust the power output of the first genset, such as to balance the load sharing of the power sources within the system. The filtered power average of the first genset may also be transmitted to the other power sources via a network (e.g., which may similarly have a load control algorithm operating at or near the second rate) and the elimination of the higher frequency components of the power averages reduces the amount of bandwidth needed on the network.

Accordingly, the systems and methods described herein allow the multiple power sources to maintain stability of the power grid while also balancing the load toward a nominal steady state. In this way, the systems and methods described herein simplify the integration of power sources into power grids (e.g., micro-grids) by reducing the need for a high bandwidth network and ensuring that all power sources connected to the power grid are operating optimally according to respective strengths. Further, the systems and methods reduce the expense, time, and maintenance in setting up micro-grids while also allowing for renewable power sources (e.g., solar or wind) to be integrated into the micro-grid.

### Power Generation Systems in Various Exemplary Embodiments

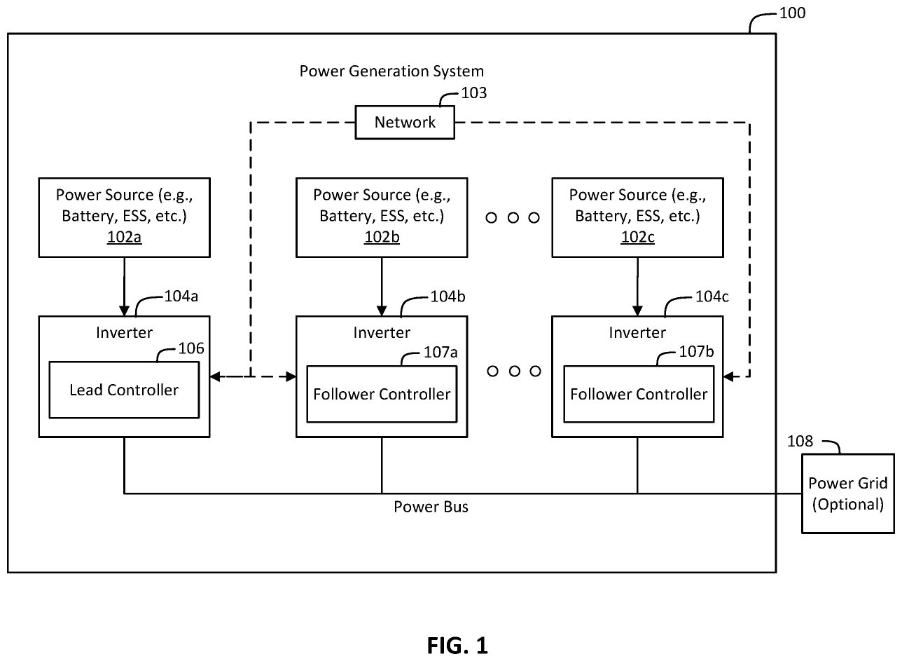

Referring to FIG. 1, a block diagram illustrating a power generation system 100 is shown, according to an exemplary embodiment. The power generation system 100 includes one or more power sources 102a-102c, one or more inverters 104a-104c, a power grid 108, and a network 103 (e.g., a communications network). Although three power sources 102a-102c are depicted, it is to be appreciated that in some embodiments additional or fewer power sources 102a-102c may be implemented in the power generation system 100. In some embodiments, the power source 102a is a first battery coupled to a first inverter 104a among a plurality of inverters 104a-104c. In some embodiments, the first inverter 104a includes a leader controller 106. In some embodiments, the power source 102b is a second battery coupled to a second inverter 104b among a plurality of inverters 104a-104c. In some embodiments, the second inverter 104b includes a follower controller 107a/107b.

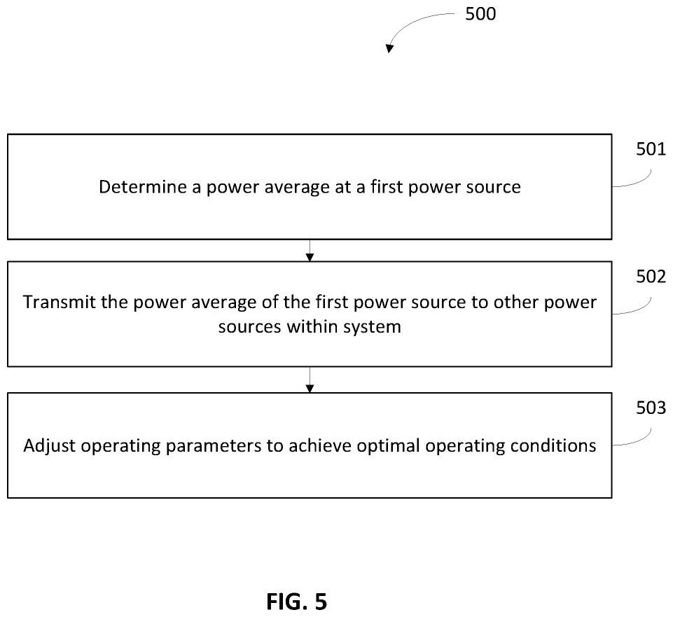

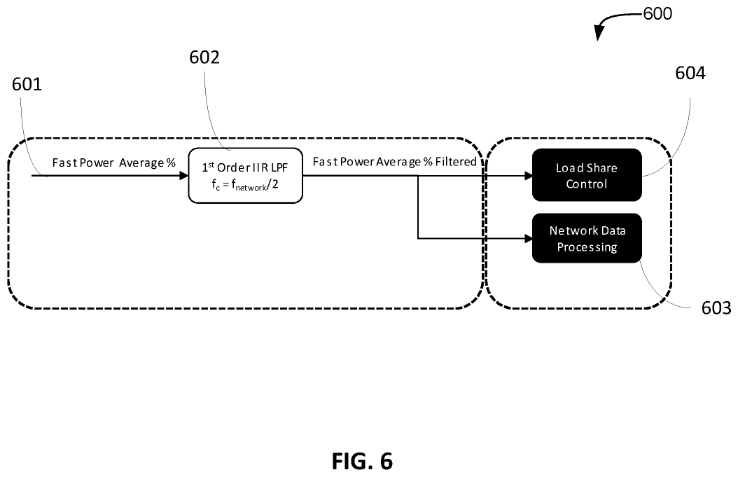

The leader controller 106 may be configured to determine whether a grid forming power source is present and coupled to the power generation system 100, determine a power target to achieve a power objective based on information received from the grid-forming power source in some embodiments, and transmit, via a network 103, the power target to the second inverter 104b. In some embodiments, the follower controllers 107a-107b are configured to receive the power target and adjust the power output of the second battery 102b such that a filtered power average of the second battery 102b is adjusted toward the filtered power average of the first battery 102a. More information about the filtered power average of the batteries 102a-102c is provided below with respect to FIGS. 5-6.

In some embodiments, adjusting, by the follower controller 107a, the power output of the second battery 102b comprises increasing the power output of the second battery 102b in response to determining that the filtered power average of the second battery 102b is lower than the filtered power average of the first battery 102a. In some embodiments, adjusting, by the follower controller 107a, the power output of the second battery 102b comprises decreasing the power output of the second battery 102b in response to determining that a power average percentage of the second battery 102b is higher than the power average percentage of the first battery 102a. In some embodiments, the leader controller 106 can assign one of the plurality of inverters 104a-104c to be the grid-forming power source if the leader controller 106 determines that the grid-forming power source is not present. In some embodiments, the follower controller 107a can balance a load share among the plurality of inverters 104b-104c and one or more other power sources 102a-102c targeting the power target. In some embodiments, the one or more other power sources 102a-102c can include at least one of a genset, a fuel cell, a photovoltaic cell, or a wind turbine.

The power sources 102a-102c may each be connected in parallel to a power bus through the one or more inverters 104a-104b. Each of the inverters 104a-104c can be configured to receive DC power from each of the power sources 102a-102c and condition the DC power to a required AC output (e.g., a grid paralleling AC output, etc.). Specifically, the inverters 104a-104b may each include a controller which is configured to control operation of the lead inverter to provide the conditioned response. In some embodiments, the inverters 104a-104c may include either a lead controller or a follower controller. For example, the inverter 104a includes a lead controller 106 while the inverters 104b and 104c include a follower controller 107a-107b.

In some embodiments, the lead controller 106 may be configured to determine a power target to achieve a power objective for the power generation system 100 and communicate the power target to the follower controllers 107a-107b to cause the power target to be implemented in each of the power sources 102a-102c included in the power generation system 100. In some embodiments, the grid-forming power source may be a genset. In other embodiments, the grid-forming power source may be an inverter (e.g., inverters 104a-104c) if no other grid-forming power sources are present in the power generation system 100. A grid-forming power source can be defined as inverters which direct power from the power sources 102a-102c in a highly controlled way to deliver power to a grid. Specifically, the grid-forming inverter can direct power from the power sources 102a-102c to the power grid by maintaining an internal voltage phasor which is controlled/matched to the voltage phasor of the power grid 108.

In some embodiments, the inverters 104a-104c may be bi-directional inverters. If a grid-forming power source is on the AC bus forming power signal of one or more phases, the inverters 104a-104c can configure themselves into grid following mode and push power to the power grid 108 or pull power from the power grid 108 to achieve a power target received from the grid-forming power source. If no grid-forming power source is on the AC bus, the lead inverter 104a may configure itself to be a grid-forming power source for the others to follow and the power generation system 100 may operate in a grid-forming mode. In one embodiment, the inverters configure themselves to provide a backup grid source in case the primary grid-forming inverter (or other source) is not available.

The controller may include a processor, a memory, and/or an input/output interface. The controller is configured to control the operation of the respective device (e.g., generator or inverter). The memory may be any sort of non-transitory machine-readable storage medium including machine readable instructions that, when executed by the processor, cause the processor to perform, assist in performing, or otherwise implement the operations and methods described herein. In some embodiments, the input/output interface may allow the controller to communicate with other electronic devices (e.g., a personal computer, a server system, sensors, etc.). In some embodiments, the input/output interface may allow for an interface or connection between the processor and one or more sensors such that the controller can monitor or detect electrical parameters of electrical power on the common bus or operating states of the respective device. The controller is configured to operate, execute, or assist in performing a power output control algorithm. The power output control algorithm of the inverter is configured to determine a power target to achieve a power objective based on the information received from either the grid-forming power source or the grid-forming inverter. Further, the power output control algorithm of the inverter is configured to adjust an amount (e.g., or magnitude) of power output via the inverter based on the power target.

In some embodiments, the power sources 102a-102c each are configured to electrically connect to the power grid 108 (e.g., common terminal or common terminals depending upon type of power and particular applications) through the inverters 104a-104c. In some embodiments, the respective output terminals of the power sources 102a-102c may be connected to the common bus via a transfer switch, fuse, ATS, or other contact that may be used to electrically connect and disconnect the respective power source from the power grid 108. In some embodiments, a power source may include a generator, a generator set, a turbine, power plant, solar power, battery device, energy storage system (ESS) or any device or system that is configured to supply electrical power to the power grid 108.

The inverters 104a-104c are communicably coupled to the network 103 and configured to transmit and receive data via the network 103 to other inverters 104a-104c in the system. In some embodiments, the network 103 is a digital communications network. The network 103 may include one or more routers, switches, or other communications hardware that are configured to route information between the inverters 104a-104c, a server system, and/or the internet.

Each of the inverters 104a-104c can include either a lead controller 106 or a follower controller 107a-107b. The controllers 106 and 107a-107b may include one or more processors, a memory device, sensors, and an input/output interface. The memory may be configured to store machine executable instructions thereon that, when executed by the one or more processors, cause the processors to perform or assist in performing any of the operations, methods, or processes described herein. In some embodiments, the input/output interface is configured to allow the respective power source to communicate via the network or directly with other power sources. In some embodiments, the sensors are configured to monitor various operating parameters of the power source such as the current output power, the frequency or voltage at an output terminal (e.g., and thereby electrical parameter of power on the power grid 108), or other operating parameters of the power source. The lead controller 106 is configured to run a load share algorithm. The load share algorithms are generally configured to attempt to maximize the operating parameters of each of the power sources.

It is to be appreciated that the load share algorithm may include different operation parameters or goals depending upon the particular power sources. For example, a load share algorithm of a power source may be designed to attempt to match a current output power to total power source power capacity percentage of the power source (e.g., a power average of the power source) to the current output power to total power source power capacity of the other power sources (e.g., a power average of the other power sources) in the system. That is, the load share algorithm of the power sources are configured to adjust power outputs of respective power sources such that all power sources in the system are equally sharing the load as a percentage of respective output capacities. In this way, the load share algorithm of the power sources reduces the potential for some power sources over working and some power sources receiving (e.g., instead of outputting) power, which ensures that the longevity and efficiency of the power sources are maximized.

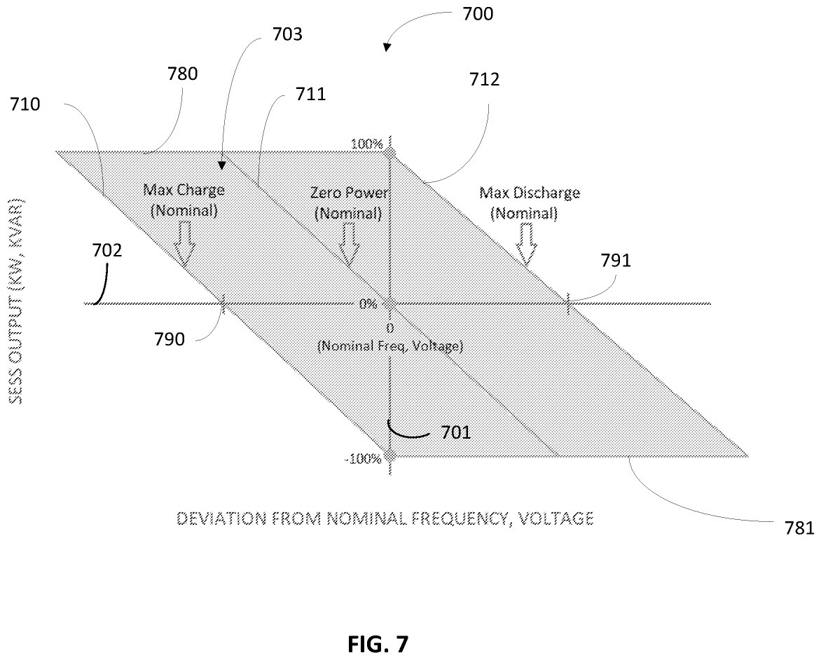

In another example, an ESS may have different load share algorithm parameters or goals. For example, in some embodiments, the ESS load share algorithm may dynamically set droop parameters such that the ESS can quickly and efficiently remove power (e.g., charge) when the frequency of the power grid 108 is too high and supply power to the power grid 108 when the frequency is too low. The amount of power that the ESS supplies or receives from the power grid 108 may be expressed as a linear function relative to the frequency. In some embodiments, the ESS is configured to dynamically alter the linear function (e.g., slope) or set points according to the power averages of the other power sources. The droop function of the ESS is further discussed in reference to FIGS. 7-9.

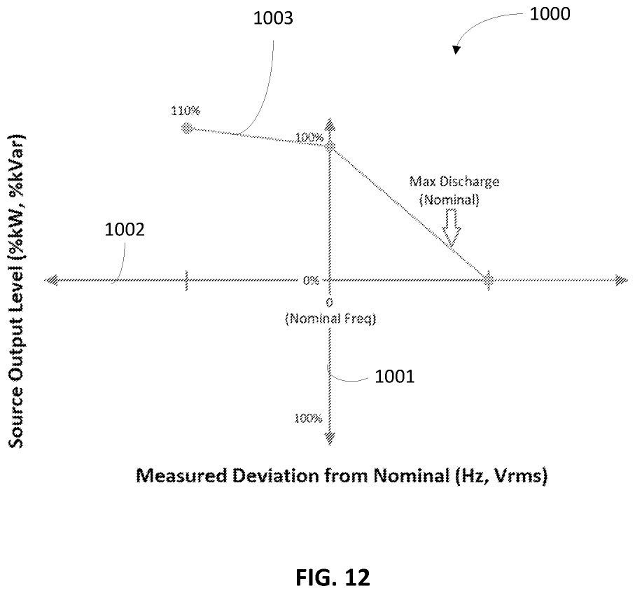

In another example, a one-way power source such as wind or solar power in the power generation system 100 may have other algorithm parameters or goals. For example, the one-way power source may also have droop parameters, however, with the exception that the one-way power sources may not receive power from the grid. The one-way power source may have a load share control algorithm that is configured to act according to the droop function. The droop function of the one-way power source is generally configured to curtail the output power of the one-way power source as the frequency on the power grid 108 exceeds a nominal value (e.g., 50-60 Hz). The droop function of the one-way power source is further discussed in reference to FIG. 12.

Accordingly, the load share control algorithm of the power sources are configured to balance the load experienced by each of the power sources and the load share control algorithm of the ESS and one-way power sources (e.g., renewable power sources) are configured to quickly and efficiently absorb transients experienced on the power grid 108. The load share algorithms further allow for optimal operation parameters of each of the power sources after a time period after a transient event. For example, after the transient event, each of the power sources may iteratively or continuously adjust respective output powers to balance the loads, the one-way power source may iteratively or continuously work toward providing the maximum amount of power possible to the power grid 108 (e.g., maximum amount of renewable, clean power), and the ESS will either support the load, if desired, begin to recharge, or enter a standby mode (e.g., if fully charged and not needed to support the load). As such, the system provides a distributed topology of power sources within the power grid 108 that may communicate with one another in a low-bandwidth network and does not require a supervisory controller to maintain stability and optimal operating states, which reduces the cost and complexity of implementing the power sources within the power grid 108 or micro-grid.

As an example of the communication over the network 103, in some embodiments, the inverters 104a-104c are configured to determine respective power averages and transmit the respective power averages to the other inverters 104a-104c within the power generation system 100. The power average may be the current power output of the inverter relative to the total power capacity of the inverter. For example, the inverter 104a may be coupled to the power source 102a which is a power source with 100 kilowatts of power capacity. The power average for the power source 102a may be the current output of the power source (e.g., 1 kilowatt) divided by the power capacity (e.g., 10 kilowatts) and represented as a percentage (e.g., 10%).

In some embodiments, a power source (e.g., a grid forming power source) or the inverter coupled to the power source may initially share an output capacity (e.g., kW and/or kVar) of the power source to the other inverters and the power average may be the current power output of the power source, which may then be used by the other inverters to calculate or determine respective current power outputs to match the percentage of the current power output of the power source relative to the power output capacity of the power source. In some embodiments, the power average may indicate the percentage of load experienced by the respective power source (e.g., battery, ESS, generator set, etc.).

In some embodiments, the inverters 104a-104c may determine the respective power averages at a refresh rate (e.g., the number of times that the respective power average is updated or re-calculated per second) of 50 Hz. In some embodiments, the inverters 104a-104c may have a refresh rate that is greater than or less than 50 Hz. The inverters 104a-104c may filter the power average via a low pass filter in order to filter off the higher frequency components (e.g., transient events) of the power average to create a filtered power average. The filtered power average may be used on the respective power source for use in a load control algorithm and also transmitted to the other power sources. For example, in some embodiments, the first inverter 104a may update or recalculate a respective power average at a rate of 50 Hz (e.g., update the respective power average 50 times per second) and pass the updated or recalculated power average through a low pass filter (e.g., with a cutoff frequency of 0.5 Hz) in order to generate a filtered power average, and the filtered power average may be transmitted via the network 103 to other inverters. In this way, the higher frequencies of the power average are filtered and a filtered power average can be transmitted via the network 103. Further discussion of the calculation and filtering of the power average is discussed below in reference to FIG. 5.

In some embodiments, the inverters 104a-104c each communicate respective power averages to the other inverters 104a-104c and the load control algorithm of each of the inverters 104a-104c may work to balance out the power averages such that each of the power sources (e.g., generator sets) are operating with maximized efficiency. For example, other power sources may use the power average to ensure that each power source is outputting a similar power average while also maintaining grid stability (e.g., stability of frequency and voltage on the power grid 108). The local load control algorithm is configured to adjust the power output of the respective power source in an attempt to ensure that all generator sets are sharing the load equally (e.g., such that each power source is outputting a similar percentage of power relative to respective output capacities). The local load control algorithm may operate on a loop at the second rate (e.g., 1 Hz).

In some embodiments, a power source (not shown) and may be designated as the grid former (e.g., a grid-forming genset or grid-forming ESS). In such embodiments, the inverters 104a-104c may operate in a grid following mode either pushing or pulling power to the power grid 108. In some embodiments, any of the inverters 104a-104c may be designated as the lead inverter. For example, in some embodiments, the inverter with the highest identification number may be designated as the lead inverter. As another example, the inverter with the lowest identification number may be designated as the lead inverters. The lead inverter is configured to receive the power signal (e.g., 50 Hz-60 Hz) from the grid-forming power source, determine a power target to achieve power objective based on the power signal received from the grid-forming power source, and send the power target to the follower inverters to be implemented in the follower inverters. That is, each of the controllers 106 and 107a-107b can be configured to either identify, communicate, or otherwise set a particular power source as the grid-forming power source.

The lead controller 106 in the lead inverter 104a associated with the grid-forming power source may not run a load control algorithm. Rather, the lead controller 106 may maintain the frequency and voltage of the electrical power on the power grid 108 within pre-determined ranges (e.g., +/−10% of 60 hertz, +/−10% 120 volts). The lead inverter 104a may then determine the power average of the first power source 102a which in this case the grid-forming power source and transmit the power average via the network 103 to the other inverters 104b-104c in the power generation system 100. The other power sources may then use the received power average of the first power source 102a to balance the load share and maintain grid stability. In some embodiments, the lead controller 106 may limit a current power output locally at a high execution rate (e.g., 50 Hz) to prevent reverse power while balancing and to control ramp load and ramp unload.

In some embodiments, a gird-forming power source may not be part of the power generation system 100. In such an embodiment, one of the inverters 104a-104c may be designated as a grid-forming power source so that the other inverts may follow. In one embodiment, the inverters 104a-104c configure themselves to provide a backup grid source in case the primary grid-forming inverter (or other source) is not available and rollover in a set priority basis.

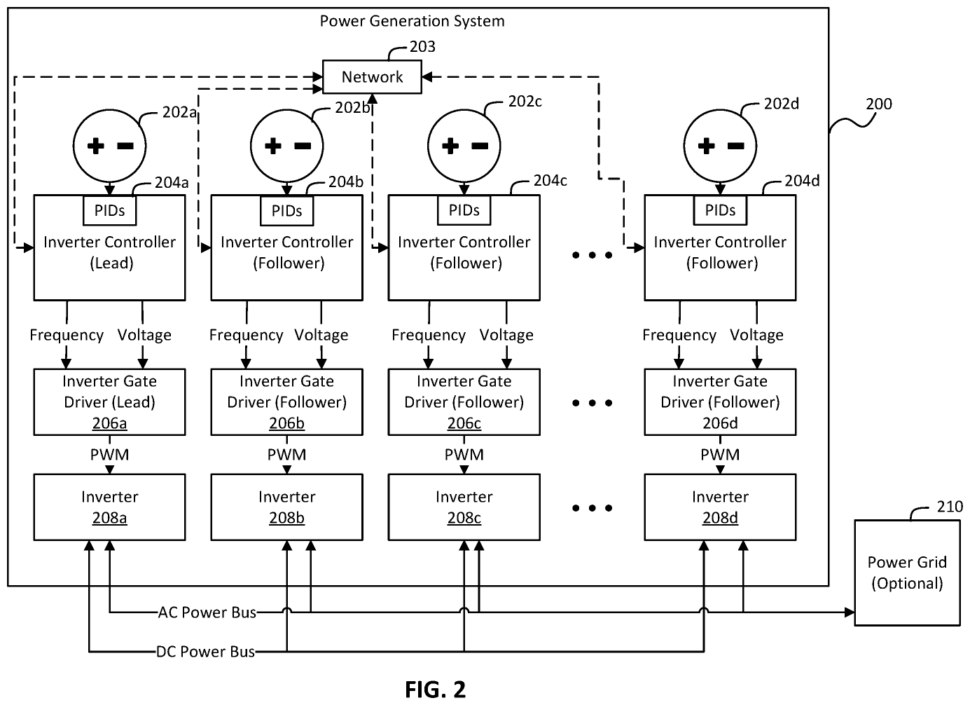

Referring now to FIG. 2, a block diagram illustrating a second embodiment of a power generation system 200 is shown according to an exemplary embodiment. The power generation system 200 can include one or more power sources 202a-202d. In some embodiments, the one or more power sources 202a-202d may be batteries or energy storage systems. In other embodiments, the power sources 202a-202d may be renewable power sources (e.g., photovoltaic cells, wind, etc.), gensets, or any other type of power source. The power generation system 200 may be optionally coupled to a power grid 210. The one or more power sources 202a-202d may be connected to one or more inverter controllers 204a-204d which control one or more inverters 208a-208d. The inverter controllers 204a-204b may be proportional-integral-derivative (PID) controllers. In some embodiments, one of the inverter controllers 204a-204d may be designated as the lead controller which is configured to determine a power target for the other follower targets to implement. Specifically, the lead controller may be configured to run a load sharing algorithm which determines the power targets (e.g., frequency, voltage, etc.).

The controllers 204a-204d are configured to determine whether a grid-forming power source is present in the power generation system 200. For example, in the embodiment demonstrated in power generation system 200, a grid-forming genset (not pictured) may be electrically connected in parallel to the power sources 202a-202d in the power generation system 200. In such a case, the power generation system 200 would operate in a grid-following mode. In a grid-following mode, the lead controller 204a would receive a system power target from the grid-forming getset and communicate the power target to the follower controllers 204b-204d. Then, each of the follower controllers 204b-204d would determine one or more operation parameters (e.g., frequency, voltage, PWM signal, etc.) which could be used to implement the power target for each respective inverter and balance the load in order to meet the power target. If the controllers 204a-204d determine that no grid-forming power source is present, one of the inverters 208a-208d may be designated to be the grid former and the power generation system 200 would operate in a grid-forming mode. In such a case, the lead controller 204a may determine the power target based on the power load placed on the power generation system 200 as opposed to receiving the power target from the grid-forming power source (e.g., genset). The lead controller 204a may then communicate the power target to the follower controllers 204b-204d. In some embodiments, the power sources 202a-202d may pull power from the power grid 210 when the power generation system 200 is operating in a grid following mode. In some embodiments, the power sources 202a-202d may push power to the power grid 210 when the power generation system 200 is operating in a grid-forming mode. In some embodiments, each of the follower controllers 204a-204d may run a load balancing/load sharing algorithm to ensure that the load is being equally shared between the inverters 208a-208d and that the power generation system 200 is operating as efficiently as possible.

The follower controllers 204a-204d may include one or more processors, a memory device, sensors, and an input/output interface. The memory may be configured to store machine executable instructions thereon that, when executed by the one or more processors, cause the processors to perform or assist in performing any of the operations, methods, or processes described herein. In some embodiments, the input/output interface is configured to allow the respective power source to communicate via the network or directly with other power sources. In some embodiments, the sensors are configured to monitor various operating parameters of the power source such as the current output power, the frequency or voltage at an output terminal (e.g., and thereby electrical parameter of power on the power grid), or other operating parameters of the power source. The lead controller 204a is configured to run a load share algorithm. The load share algorithms are generally configured to attempt to maximize the operating parameters of each of the power sources 202a-202d.

It is to be appreciated that the load share algorithm may include different operation parameters or goals depending upon the particular power sources. For example, a load share algorithm of a power source may be designed to attempt to match a current output power to total power source power capacity percentage of the power source (e.g., a power average of the power source) to the current output power to total power source power capacity of the other power sources (e.g., a power average of the other power sources) in the system. That is, the load share algorithm of the power sources are configured to adjust power outputs of respective power sources such that all power sources in the system are equally sharing the load as a percentage of respective output capacities. In this way, the load share algorithm of the power sources reduce the potential for some power sources over working and some power sources receiving (e.g., instead of outputting) power, which ensures that the longevity and efficiency of the power sources are maximized.

For example, in power generation system 200, the power sources 202a-202d may be batteries or an ESS may have different load share algorithm parameters or goals. For example, in some embodiments, the ESS load share algorithm may dynamically set droop parameters such that the ESS can quickly and efficiently remove power (e.g., charge) when the frequency of the power grid is too high and supply power to the power grid 210 when the frequency is too low. The amount of power that the ESS supplies or receives from the power grid 210 may be expressed as a linear function relative to the frequency. In some embodiments, the ESS is configured to dynamically alter the linear function (e.g., slope) or set points according to the power averages of the other power sources 202a-202d. The droop function of the ESS is further discussed in reference to FIGS. 7-9.

Accordingly, the load share control algorithm of the power sources 202a-202d are configured to balance the load experienced by each of the power sources 202a-202d and the load share control algorithm of the ESS and one-way power sources (e.g., renewable power sources) are configured to quickly and efficiently absorb transients experienced on the power grid 210. The load share algorithms further allow for optimal operation parameters of each of the power sources 202a-202d after a time period after a transient event. For example, after the transient event, each of the power sources 202a-202d may iteratively or continuously adjust respective output powers to balance the loads, the one-way power source may iteratively or continuously work toward providing the maximum amount of power possible to the power grid 210 (e.g., maximum amount of renewable, clean power), and the ESS will either support the load, if needed, begin to recharge, or enter a standby mode (e.g., if fully charged and not needed to support the load). As such, the system provides a distributed topology of power sources within the power grid 210 that may communicate with one another in a low-bandwidth network and does not require a supervisory controller to maintain stability and optimal operating states, which reduces the cost and complexity of implementing the power sources 202a-202d within the power grid 210 or micro-grid.

As an example of the communication over the network 203, in some embodiments, the inverter controllers 204a-204d are configured to determine respective power averages and transmit the respective power averages to the other inverter controllers 204a-204d within the power generation system 200. The power average may be the current power output of the inverter relative to the total power capacity of the inverter. For example, the inverter controller 204a may be coupled to the power source 202a which is a battery with 100 kilowatts of power capacity. The power average for the power source 202a may be the current output of the power source (e.g., 1 kilowatt) divided by the power capacity (e.g., 10 kilowatts) and represented as a percentage (e.g., 10%). In some embodiments, the inverter controllers 204a-204d coupled to the power sources 202a-202d may initially share an output capacity (e.g., kW and/or kVar) of the power sources 202a-202d to the other inverters and the power average may be the current power output of the power source, which may then be used by the other inverters to calculate or determine respective current power outputs to match the percentage of the current power output of the power source relative to the power output capacity of the power source. In some embodiments, the power average may indicate the percentage of load experienced by the respective power source (e.g., battery, ESS, generator set, etc.). In some embodiments, the inverters 204a-204d may determine the respective power averages at a refresh rate (e.g., the number of times that the respective power average is updated or re-calculated per second) of 50 Hz. In some embodiments, the inverter controllers 204a-204d may have a refresh rate that is greater than or less than 50 Hz. The inverter controllers 204a-204d may filter the power average via a low pass filter in order to filter off the higher frequency components (e.g., transient events) of the power average to create a filtered power average. The filtered power average may be used on the respective power source for use in a load sharing algorithm and also transmitted to the other power sources. For example, in some embodiments, the first inverter controller 204a may update or re-calculate a respective power average at a rate of 50 Hz (e.g., update the respective power average 50 times per second) and pass the updated or recalculated power average through a low pass filter (e.g., with a cutoff frequency of 0.5 Hz) in order to generate a filtered power average, and the filtered power average may be transmitted via the network 203 to other inverters. In this way, the higher frequencies of the power average are filtered and a filtered power average can be transmitted via the network 203. Further discussion of the calculation and filtering of the power average is discussed below in reference to FIG. 5.

In some embodiments, the inverter controllers 204a-204d communicate between each other over a local low (or high) network 203 to set and balance the overall load share between the power sources 202a-202d coupled to the local power grid 210. In some embodiments, renewable power sources are typically prioritized within the load share algorithm as they reduce fuel usage, engine wear and consumables, and extend battery lifespans and reduce battery cycle wear. If the load is below a certain threshold, any fuel-powered energy sources can be turned off and the local grid can be powered by the coupled inverters and/or renewable energy sources with either one of the inverters, or a renewable power source being the grid former (e.g., grid-forming power source or grid-forming inverter).

In some embodiments, the inverter controllers 204a-204d each communicate respective power averages to the other inverter controllers 204a-204d and the load control algorithm of each of the inverter controllers 204a-204d may work to balance out the power averages such that each of the power sources 202a-202d (e.g., generator sets) are operating at with maximized efficiency. For example, other power sources may use the power average to ensure that each power source is outputting a similar power average while also maintaining grid stability (e.g., stability of frequency and voltage on the power grid 210). The local load control algorithm is configured to adjust the power output of the respective power source in an attempt to ensure that all generator sets are sharing the load equally (e.g., such that each power source is outputting a similar percentage of power relative to respective output capacities). The local load control algorithm may operate on a loop at the second rate (e.g., 1 Hz).

In some embodiments, the first power inverter 208a and may be designated as the grid former (e.g., a grid-forming genset or grid-forming ESS) in the event that another grid-forming power source is not available to the power generation system 200. In such a case, the first inverter 208a determines a power target to achieve a power objective based on the load placed on the power generation system 200, and sends the power target to the follower inverters 208b-208d to be implemented in the follower inverters 208b-208d. That is, each of the inverter controllers 204a-204d can be configured to either identify, communicate, or otherwise set a particular inverter as the grid-forming inverter. In some embodiments, the inverter with the highest or lowest identification number can be the largest power source within the power generation system 200 (e.g., connected to the power grid 210 and online) is identified or set as the grid-forming power source. In some embodiments, an indication of the grid-forming inverter is sent or programmed into the controllers of each of the inverters associated with the other power sources. In some embodiments, a supervisory or master controller may designate the grid-forming inverter source and communicate the designation to each of the inverter controllers 204a-204d.

In some embodiments, the lead controller 204a associated with the grid-forming inverter may not run a load control algorithm. Rather, the lead controller 204a may determine the power target based on the load applied to the power generation system 200, and determine and implement one or more operating parameters (e.g., frequency and voltage of the electrical power on the power grid 210) within pre-determined ranges (e.g., +/−10% of 60 hertz, +/−10% 120 volts) to meet the power target. The lead inverter controller 204a may then determine the power average of the first power source 202a, which in this case is associated with the grid-forming inverter, and transmit the power average via the network 203 to the other inverters 204b-d in the power generation system 200. The other inverter controllers 204b-204d may then use the received power average of the first power source 202a to balance the load share and maintain grid stability. In some embodiments, the lead inverter 208a may limit a current power output locally at a high execution rate (e.g., 50 Hz) to prevent reverse power while balancing and to control ramp load and ramp unload.

In some embodiments, during load transients, the power sources 202a-202d can be configured to react under their own local control to handle the power transients in a timely fashion. The transient responses may include load step increases/decreases, voltage droop, frequency increases/decreases, etc. After the transient occurred, the load balance within the power generation system 200 and the long term grid control loops would be restored slowly to normal conditions by communicating just the slow cycle control information over the network 203.

The inverter controllers 204a-204d may be coupled to one or more gate drivers 206a-206d. The gate drivers 206a-206d can be configured to be a power amplifier that accepts a low power input (e.g., frequency, voltage, etc.) from the inverter controllers 204a-204d and transforms the low power input to a high power input which can be used to drive the inverters 208a-208d. Based on the low power input, each of the gate drivers 206a-206d may create a power input in the form of a pulse width modulation (PWM) signal which may be used to drive the inverters 208a-208d.

In the exemplary embodiment shown in FIG. 2, each of the inverters 208a-208d are coupled to a common DC power bus. In such an embodiment, is may be beneficial for each of the power sources 202a-202d to be of a similar type and a similar capacity given that each of the inverters 208a-208d will be sending power to a common DC power bus.

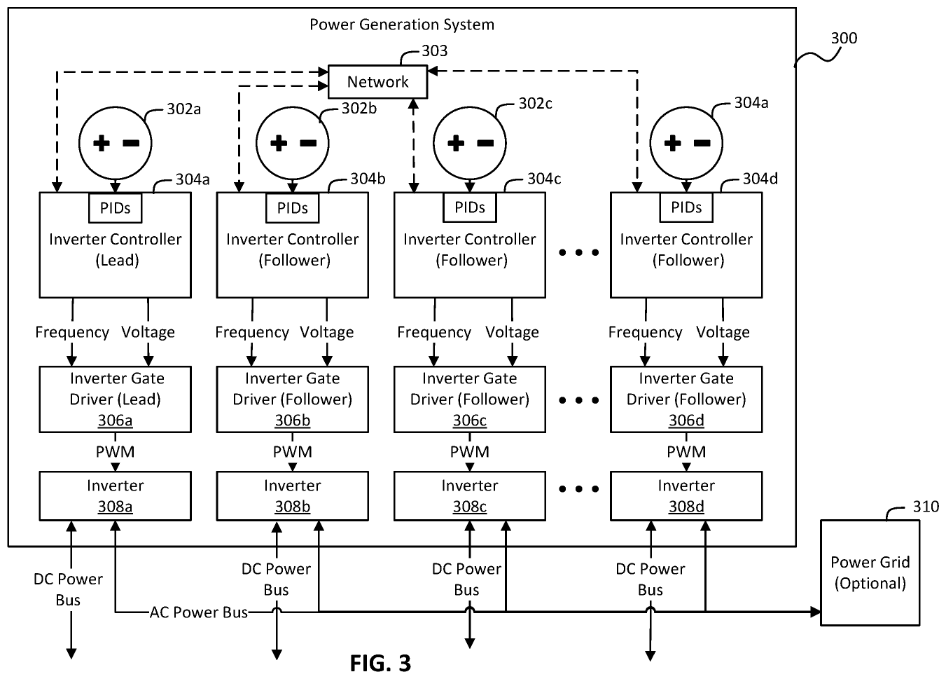

Referring now to FIG. 3, a block diagram illustrating a third embodiment of a power generation system 300 is shown according to an exemplary embodiment. The power generation system 300 can include one or more power sources 302a-302d. In some embodiments, the one or more power sources 302a-302d may be batteries or energy storage systems (ESS). Specifically, the one or more power sources 302a-302d may be batteries and/or energy storage systems of varied type and capacity (e.g., lithium-ion batteries, lead acid batteries, nickel metal hydride batteries, alkaline batteries, zinc-carbon batteries, nickel cadmium batteries, etc.) in contrast the power sources 202a-202d which may be of a similar type and similar capacity. In other embodiments, the power sources 302a-302d may be renewable power sources (e.g., photovoltaic cells, wind, etc.), gensets, or any other type of power source. The power generation system 300 may be optionally coupled to a power grid 310. The one or more power sources 302a-302d may be connected to one or more inverter controllers 304a-304d which control one or more inverters 308a-308d. The inverter controllers 304a-304b may be proportional-integral-derivative (PID) controllers. In some embodiments, one of the controllers 304a-304d may be designated as the lead controller 304a which is configured to determine a power target for the other follower targets to implement. Specifically, the lead controller 304a may be configured to run a load sharing algorithm which determines the power targets (e.g., frequency, voltage, etc.).

The controllers 304a-304d are configured to determine whether a grid-forming power source is present in the power generation system 300. For example, in the embodiment demonstrated in power generation system 300, a grid-forming genset (not pictured) may be electrically connected in parallel to the power sources 302a-302d in the power generation system 300. In such a case, the power generation system 300 would operate in a grid-following mode. In a grid-following mode, the lead controller 304a would receive a system power target from the grid-forming getset and communicate the power target to the follower controllers 304b-304d. Then, each of the follower controllers 304b-304d would determine the one or more operation parameters (e.g., frequency, voltage, PWM signal, etc.) which could be used to implement the power target for each respective inverter and balance the load in order to meet the power target. If the controllers 304a-304d determine that no grid-forming power source is present, one of the inverters may be designated to be the grid former and the power generation system 300 would operate in a grid-forming mode. In such a case, the lead controller 304a may determine the power target based on the power load placed on the power generation system 300 as opposed to receiving the power target from the grid-forming power source (e.g., genset). The lead controller 304a may then communicate the power target to the follower controllers 304b-304d. In some embodiments, the power sources 302a-302d may pull power from the power grid 310 when the power generation system 300 is operating in a grid-following mode. In some embodiments, the power sources 302a-302d may push power to the power grid 310 when the power generation system 300 is operating in a grid-forming mode. In some embodiments, each of the controllers 304a-304d may run a load balancing/load sharing algorithm to ensure that the load is being equally shared between the inverters 308a-308d and that the power generation system 300 is operating as efficiently as possible.

The controllers 304a-304d may include one or more processors, a memory device, sensors, and an input/output interface. The memory may be configured to store machine executable instructions thereon that, when executed by the one or more processors, cause the processors to perform or assist in performing any of the operations, methods, or processes described herein. In some embodiments, the input/output interface is configured to allow the respective power source to communicate via the network or directly with other power sources. In some embodiments, the sensors are configured to monitor various operating parameters of the power source such as the current output power, the frequency or voltage at an output terminal (e.g., and thereby electrical parameter of power on the power grid), or other operating parameters of the power source. The lead controller 304a is configured to run a load share algorithm. The load share algorithms are generally configured to attempt to maximize the operating parameters of each of the power sources.

It is to be appreciated that the load share algorithm may include different operation parameters or goals depending upon the particular power sources. For example, a load share algorithm of a power source may be designed to attempt to match a current output power to total power source power capacity percentage of the power source (e.g., a power average of the power source) to the current output power to total power source power capacity of the other power sources (e.g., a power average of the other power sources) in the system. That is, the load share algorithm of the power sources are configured to adjust power outputs of respective power sources such that all power sources in the system are equally sharing the load as a percentage of respective output capacities. In this way, the load share algorithm of the power sources reduce the potential for some power sources over working and some power sources receiving (e.g., instead of outputting) power, which ensures that the longevity and efficiency of the power sources are maximized.

For example, in power generation system 300, the power sources 302a-302d may be batteries or an ESS and may have different load share algorithm parameters or goals. For example, in some embodiments, the ESS load share algorithm may dynamically set droop parameters such that the ESS can quickly and efficiently remove power (e.g., charge) when the frequency of the power grid 310 is too high and supply power to the power grid 310 when the frequency is too low. The amount of power that the ESS supplies or receives from the power grid 310 may be expressed as a linear function relative to the frequency. In some embodiments, the ESS is configured to dynamically alter the linear function (e.g., slope) or set points according to the power averages of the other power sources. The droop function of the ESS is further discussed in reference to FIGS. 7-9.

Accordingly, the load share control algorithm of the power sources 302a-302d are configured to balance the load experienced by each of the power sources 302a-302d and the load share control algorithm of the ESS and one-way power sources (e.g., renewable power sources) are configured to quickly and efficiently absorb transients experienced on the power grid 310. The load share algorithms further allow for optimal operation parameters of each of the power sources 302a-302d after a time period after a transient event. For example, after the transient event, each of the power sources 302a-302d may iteratively or continuously adjust respective output powers to balance the loads, the one-way power source may iteratively or continuously work toward providing the maximum amount of power possible to the power grid 310 (e.g., maximum amount of renewable, clean power), and the ESS will either support the load, if needed, begin to recharge, or enter a standby mode (e.g., if fully charged and not needed to support the load). As such, the power generation system 300 provides a distributed topology of power sources 302a-302d within the power grid 310 that may communicate with one another in a low-bandwidth network and does not require a supervisory controller to maintain stability and optimal operating states, which reduces the cost and complexity of implementing the power sources 302a-302d within the power grid 310 or micro-grid.

As an example of the communication over the network 303, in some embodiments, the inverter controllers 304a-304d are configured to determine respective power averages and transmit the respective power averages to the other inverter controllers 304a-304d within the power generation system 300. The power average may be the current power output of the inverter relative to the total power capacity of the inverter. For example, the inverter controller 304a may be coupled to the power source 302a, which is a battery with 100 kilowatts of power capacity. The power average for the power source 302a may be the current output of the power source (e.g., 1 kilowatt) divided by the power capacity (e.g., 10 kilowatts) and represented as a percentage (e.g., 10%). In some embodiments, the inverter controller 304a coupled to the power source 302a may initially share an output capacity (e.g., kW and/or kVar) of the power source to the other inverters and the power average may be the current power output of the power source, which may then be used by the other inverters to calculate or determine respective current power outputs to match the percentage of the current power output of the power source relative to the power output capacity of the power source. In some embodiments, the power average may indicate the percentage of load experienced by the respective power source (e.g., battery, ESS, generator set, etc.).

In some embodiments, the inverter controllers 304a-304d may determine the respective power averages at a refresh rate (e.g., the number of times that the respective power average is updated or re-calculated per second) of 50 Hz. In some embodiments, the inverter controllers 304a-304d may have a refresh rate that is greater than or less than 50 Hz. The inverter controllers 304a-304d may filter the power average via a low pass filter in order to filter off the higher frequency components (e.g., transient events) of the power average to create a filtered power average. The filtered power average may be used on the respective power source for use in a load control algorithm and also transmitted to the other power sources 302a-302d. For example, in some embodiments, the first inverter controller 304a may update or recalculate a respective power average at a rate of 50 Hz (e.g., update the respective power average 50 times per second) and pass the updated or recalculated power average through a low pass filter (e.g., with a cutoff frequency of 0.5 Hz) in order to generate a filtered power average, and the filtered power average may be transmitted via the network 303 to other inverters. In this way, the higher frequencies of the power average are filtered and a filtered power average can be transmitted via the network 303. Further discussion of the calculation and filtering of the power average is discussed below in reference to FIG. 5.

In some embodiments, the inverter controllers 304a-304d communicate between each other over a local low (or high) network 303 to set and balance the overall load share between the power sources 302a-302d coupled to the local power grid 310. In some embodiments, renewable power sources are typically prioritized within the load share algorithm as they reduce fuel usage, engine wear and consumables, and extend battery lifespans and reduce battery cycle wear. If the load is below a certain threshold, any fuel-powered energy sources can be turned off and the local grid 310 can be powered by the coupled inverters and/or renewable energy sources with either one of the inverters, or a renewable power source being the grid former (e.g., grid-forming power source or grid-forming inverter).

In some embodiments, the inverters controllers 304a-304d each communicate respective power averages to the other inverter controllers 304a-304d and the load control algorithm of each of the inverter controllers 304a-304d may work to balance out the power averages such that each of the power sources (e.g., generator sets) are operating with maximized efficiency. For example, other power sources may use the power average to ensure that each power source is outputting a similar power average while also maintaining grid stability (e.g., stability of frequency and voltage on the power grid 310). The local load control algorithm is configured to adjust the power output of the respective power source in an attempt to ensure that all generator sets are sharing the load equally (e.g., such that each power source is outputting a similar percentage of power relative to respective output capacities). The local load control algorithm may operate on a loop at the second rate (e.g., 1 Hz).

In some embodiments, the first power inverter 308a and may be designated as the grid former (e.g., a grid-forming genset or grid-forming ESS) in the event that another grid-forming power source is not available to the power generation system 300. In such a case, the first inverter controller 304a coupled to the first inverter 308a determines a power target to achieve power objective based on the load placed on the power generation system 300, and sends the power target to the follower inverter controllers 304b-304d to be implemented in the follower inverters 308b-308d. That is, each of the inverter controllers 304a-304d can be configured to either identify, communicate, or otherwise set a particular inverter as the grid-forming inverter. In some embodiments, the inverter with the highest or lowest identification number can be the largest power source within the system (e.g., connected to the power grid 310 and online) is identified or set as the grid-forming power source. In some embodiments, an indication of the grid-forming inverter is sent or programmed into the controllers of each of the inverters associated with the other power sources. In some embodiments, a supervisory or master controller may designate the grid-forming inverter source and communicate the designation to each of the inverter controllers 304a-304d.

In some embodiments, the lead controller 304a associated with the grid-forming inverter may not run a load control algorithm. Rather, the lead controller 304a may determine power target based on the load applied to the power generation system 300, and determine and implement one or more operating parameters (e.g., frequency and voltage of the electrical power on the power grid 310) within pre-determined ranges (e.g., +/−10% of 60 hertz, +/−10% 120 volts) to meet the power target. The lead inverter controller 304a may then determine the power average of the first power source 302a which in this case is associated with the grid-forming inverter, and transmits the power average via the network 303 to the other inverter controllers 304b-d in the power generation system 300. The other power sources may then use the received power average of the first power source 302a to balance the load share and maintain grid stability. In some embodiments, the lead inverter 308a may limit a current power output locally at a high execution rate (e.g., 50 Hz) to prevent reverse power while balancing and to control ramp load and ramp unload.

In some embodiments, during load transients, the power sources 302a-302d can be configured to react under their own local control to handle the power transients in a timely fashion. The transient responses may include load step increases/decreases, voltage droop, frequency increases/decreases, etc. After the transient occurred, the load balance within the power generation system 300 and the long-term grid control loops would be restored slowly to normal conditions by communicating just the slow cycle control information over the network 303.

The inverter controllers 304a-304d may be coupled to one or more gate drivers 306a-306d. The gate drivers 306a-306d can be configured to be a power amplifier that accepts a low power input (e.g., frequency, voltage, etc.) from the inverter controllers 304a-304d and transforms the low power input to a high power input which can be used to drive the inverters 308a-308d. Based on the low power input, the gate driver 306a may create a power input in the form of a pulse width modulation (PWM) signal which may be used to drive the inverters 308a-308d.

In the exemplary embodiment shown in FIG. 3, each of the inverters 308a-308d are coupled to separate DC power buses. In such an embodiment, the power sources 302a-302d may be varied in type and/or capacity as described above. Further, such an embodiment enables a fast-reacting energy storage system (e.g., super capacitors, ultra-capacitors, etc.) to primarily provide the transient response when the power generation system 300 experiences a transient event. This allows the slower cycle energy storage sources (e.g., certain batteries, etc.) to be operated to better meet the average load, increase the battery energy density, and minimize damaging fast cycles and heating. Varied energy sources and batteries can also be managed and load leveled separately to account for differing battery needs (e.g., some batteries may need charging, some batteries may need discharging, etc.), different battery conditions, varied battery aging, and voltage/capacity reductions that would normally make the batteries of varied types and capacities unusable in a common DC bus architecture.

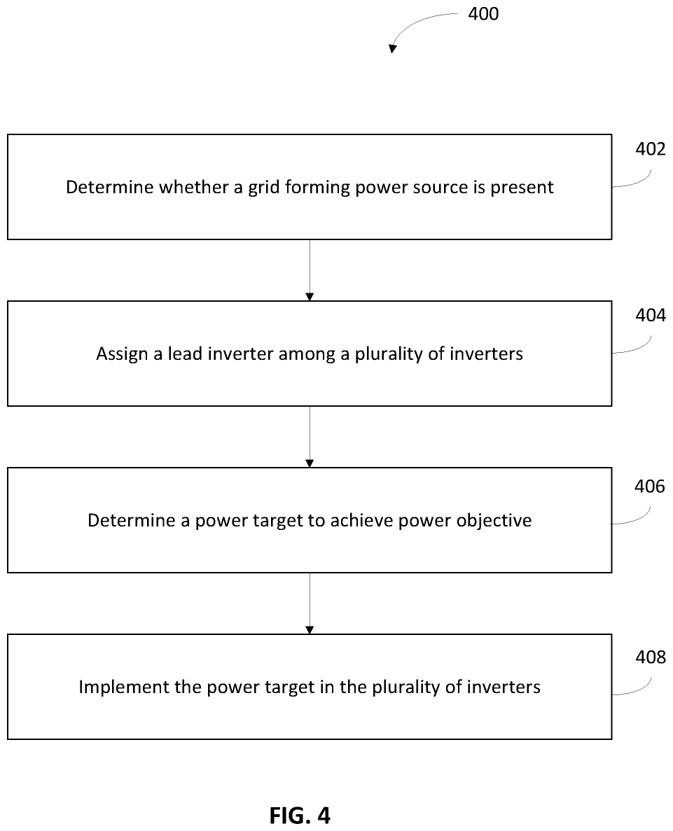

Referring now to FIG. 4, a flow diagram of a method 400 of controlling power on a power grid (e.g., power grid 108, power grid 210, power grid 310, etc.) is shown according to an exemplary embodiment. Specifically, the method 400 is directed toward determining and implementing a power target in a plurality of inverters included in a power generation system. The method 400 may be implemented in any of the power generation systems (e.g., power generation system 100, power generation system 200, and power generation system 300) described above. For the purposes of simplicity, the method 400 will be described below as it can be implemented in power generation system 100. However, this description is not meant to be narrowing and the method 400 could be similarly implemented in power generation system 200 and power generation system 300.

Generally, the method 400 includes determining whether a grid-forming power source is present or coupled to the power generation system 100, assigning a lead inverter 104a among a plurality of inverters 104a-104c. In some embodiments, the lead inverter 104a comprises a lead controller 106. The method 400 can also include determining, by the lead controller 106, a power target to achieve a power objective based on information received from the grid-forming power source. The method 400 can also include causing the power target to be implemented in the plurality of inverters 104a-104c. In some embodiments, the method 400 further includes assigning one of the plurality of inverters 104a-104c to be the grid-forming power source if the lead controller 106 determines that the grid-forming power source is not present. In some embodiments, the method 400 can further include determining the power target to either send power to a grid or receive power from the grid to accomplish the power objective of the grid. In some embodiments, the method 400 can further include assigning one or more of the plurality of inverters 104a-104c as follower inverters 104b-104c, wherein each of the follower inverters 104b-104c includes a follower controller 107a-107b.

In some embodiments implementing the power target includes transmitting, by the lead inverter 104a over a network 103, the power target to one or more of the plurality of inverters 104a-104c, receiving, at each of the follower inverters 104b-104c, via the network 103, the power target; and adjusting, at the follower inverters 104b-104c, the power output of the follower inverters 104b-104c such that a power output of the follower inverter 104c is adjusted toward the power target. In some embodiments, adjusting the power output of the follower inverters 104b-104c includes increasing the power output of the follower inverters 104b-104c in response to determining that the power output of the follower inverters 104b-104c is lower than the power target. In some embodiments, adjusting the power output of the follower inverters 104b-104c comprises decreasing the power output of the follower inverters 104b-104c in response to determining that the power output of the follower inverters 104b-104c is higher than the power target.

At operation 402, one of the inverters 104a-104c determines whether a grid-forming power source is coupled to the power generation system 100. For example, in some embodiments, one of those inverters 104a-104c may receive a signal for a communication pin associated with the inverters 104a-104c which indicates that a grid-forming power source is coupled to the power generation system. As described above, if a grid-forming power source is coupled to the power generation system 100, then the power generation system 100 operates is a grid-following mode. Alternatively, if a grid-forming power source is not coupled to the power generation system 100, then one of the inverters 104a-104c may be designated as the “grid former.” If one of the inverters is designated as a grid-forming inverter, then the power generation system 100 operates in a grid-forming mode.

At operation 404, one of the inverters 104a-104c is assigned as a lead inverter 104a among the plurality of inverters in the power generation system 100. In the case where the power generation system 100 is operating in a grid-following mode, the inverter with the highest identification number or the lowest identification number may be assigned as the lead inverter. For example, in the example show in FIG. 1, the inverter 104a may be designated as the “lead inverter.” In the case where the power generation system 100 is operating in a grid-forming mode, the grid-forming inverter will be designated as the “lead inverter.” In both cases, the lead inverter 104a includes the lead controller (e.g., lead controller 106) which is configured to balance the load share among the power sources 102a-102c.

At operation 406, the lead controller 106 determines a power target to achieve a power objective. The power target may be defined as the amount of power required from the power generation system 100 to meet a power objective (e.g., satisfy the load placed on the system, etc.). In some embodiments, the lead controller 106 determines a power target based on information received from the grid-forming power source. For example, when the power generation system 100 is operating in a grid-following mode (e.g., a grid-forming power source is present), then the lead controller 106 may be configured to receive a power target from the grid-forming power source. For example, the grid-forming power source may determine that the power generation system 100 needs to supply power which would support a 9 kilowatt load. In this example, the lead controller 106 would receive the power target (e.g., 9 kilowatts) from the grid-forming power source. The lead controller 106 would then run a load sharing algorithm to balance the power target between each of the power sources 102a-102c.

In some embodiments, the lead controller 106 determines a power target independently. Specifically, in the case where the power generation system 100 is operating in a grid-forming mode (e.g., no grid-forming power source is present), the lead inverter 104a is configured to determine any current system conditions (e.g., load placed, power grid status, etc.) for the power generation system 100 and communicate the system conditions to the lead controller 106. The lead controller 106 may then determine the power target based on the system conditions detected by the lead inverter 104a. For example, the lead inverter 104a may determine that a 10 kilowatt load is currently placed on the power generation system 100 and that the power grid 108 is only able to provide 1 kilowatt of power currently. In this case, the lead controller 106 would determine that a power target of 9 kilowatts would successfully satisfy the load in conjunction with the power grid 108.

At operation 408, the lead controller 106 implements the power target in the plurality of inverters by running a load sharing/load balancing algorithm and then communicating individual power targets for each of the other inverters. More information about the load sharing algorithm is provided below with respect to FIGS. 5-12. Returning to the examples above, the lead controller 106 may execute a load sharing algorithm and determine that the 9 kilowatt power target can be equally balanced if each power source 102a-102c pushes out 3 kilowatts. In one embodiment, the lead controller 106 may communicate the individual power target (e.g., 3 kilowatts) to each of the other inverters 104b-104c, and more specifically to the follower controllers 107a-107b through the network 103. In another embodiment, the lead controller 106 may communicate the individual power target to the follower controller next to it (e.g., follower controller 107a) through the network 103. Then in return, the follower controller 107a may communicate the individual power target received from the lead controller 106 to the follower controller next to it (e.g., follower controller 107b). This process may repeat until each follower controller 107a-107b has received the individual power target. Once each controller has determined/received a power target, the controllers 106 and 107a-107b operate the inverters 104a-104c to ensure that the power target is met.

### Load Control Algorithms for Managing the Power Generation Systems

Referring now to FIG. 5, a flow diagram of a method 500 of controlling power on a power grid is shown according to an exemplary embodiment. In particular, the method 500 is directed toward achieving a nominally balanced steady state operating point (e.g., steady and optimized operating parameters of each power source) in a power grid via communicating over a network (e.g., a limited bandwidth network due to the state of current technology and costs of implementing a state-of-the-art network).

In operation 501, a first power source determines a power average (e.g., power average of the first power source). The first power source is connected to a power grid (e.g., a micro-grid) and may be experiencing a load. A controller of the first power source may determine the current output power of the first power source and determine the power average. The power average may be a percentage of the current output power of the first power source and the total capacity of the first power source. Further, the controller of the first power source may filter the power average such as to slow down the refresh rate of the power average. In some embodiments, the controller of the first power source filters (e.g., and/or slows the refresh calculation of) the power average to a refresh rate of less than a desired network rate. For example, in some embodiments, a network communicably coupled to the first power source may have limited bandwidth that is not suitable to transmit the power average at high frequencies (e.g., 50 Hz). The first power source may slow the refreshing or recalculation rate of the power average to a rate that is suitable to be transmitted on the network (e.g., 1 Hz). In addition, in some embodiments, the controller may filter the power averages via a low pass filter having a cutoff frequency of the network rate (e.g., the rate at which the network can transmit without having bandwidth issues) divided by 2. For example, if data (e.g., power averages) from the power sources can be sent and received at 1 hertz (Hz) over the network, the first power source may filter the power average with a low pass filter having a cutoff frequency of 0.5 Hz before transmitting the power average. Filtering the power average is discussed in further detail with respect to FIG. 6.

In an operation 502, the power average (e.g., determined or filtered power average) is transmitted from the first power source to the other power sources within the system via the network. The transmission may be done digitally via the network. In some embodiments, the power average is received by each of the other power sources and used to control the power (e.g., load sharing) on the power grid. In some embodiments, the other power sources may similarly determine respective power averages (e.g., filtered power averages to preserve bandwidth) and may transmit the respective power averages to multiple power sources on the power grid (e.g., including the first power source). In some embodiments, the first power source may also include an indication of the identity of the first power source such that the other power sources can identify which power source within the system the power average belongs to.

In an operation 503, the first power source and other power sources use the power average to achieve optimal steady state operating conditions (e.g., via a local load control algorithm operating at or near the second rate). That is, the power sources may use the power average in a local load control algorithm to try and match the power average such that each of the power sources are sharing the load of the power grid. For example, other power sources in the system may work to achieve a nominally balanced steady state operating point based on the filtered power average received from one or more of the other power sources and the local load control algorithm. In some embodiments, the first power source may be a grid-forming power source. The grid-forming power source may regulate the frequency and voltage on the power grid without adjusting the grid-forming power sources load share.

For example, other power sources within the system may receive the power average (e.g., a filtered power average) from the first power source and use the filtered power average in a local load control algorithm (e.g., operating at or near the second rate) in an attempt to match the filtered power average of the first power source (e.g., the grid-forming power source). In an example where one or more of the other power sources have a higher power average than the power average of the first power source, the one or more of the other power sources may reduce respective power outputs in an attempt to match the power average of the first power source. In response, the first power source may detect or determine that the frequency and voltage on the power grid is falling, and in turn, begin to output more power, thereby balancing the load share (e.g., by increasing the power average of the first power source and lowering the power average of the one or more other power sources).

In another example, where one or more of the other power sources have a lower power average than the power average of the first power source, the one or more other power sources may increase respective power outputs. In response, the first power source may detect or determine that the frequency and voltage on the power grid is rising, and in turn, begin to decrease power output of the first power source, thereby balancing the load share (e.g., by increasing the power average of the other power sources and lowering the power average of the first power source). In some embodiments, the other power sources (e.g., power sources that are not the grid-former power source) may similarly calculate and filter respective power averages before comparing their respective power average to the power average of the first power source (e.g., the power average of the grid-former power source).

Referring now to FIG. 6, a diagram 600 of determining power averages of a power source according to constraints of a network is shown according to an exemplary embodiment. That is, the diagram depicts a process flow of a controller of a power source in determining a power average suitable for transmission over a limited bandwidth network.

The power source may calculate a power average at a first rate 601 (e.g., 50 Hz) that contains too high of frequencies for the network bandwidth to accommodate. The network rate that is a rate that allows for transmission of the power average over the limited bandwidth network. Accordingly, the load control algorithm may be set to a second rate that both accommodates the network rate (e.g., selected due to bandwidth constraints of the network) and the filtered power average may be filtered via a low pass filter having a cutoff frequency of one half of the second rate (e.g., which may be selected to be the network rate). The power source feeds the power average at the first rate 601 into a low pass filter 602 to remove frequency content greater than the network rate (e.g., 1 Hz) divided by 2. The low pass filter 602 may be a first order low pass filter with a cutoff frequency of the network rate divided by 2. The low pass filter 602 may then output the power average at the second rate (e.g., the filtered power average) to the other power sources via the network 603 and to a load share control algorithm 604 on the power source. The filtering ensures that the frequency content above the Nyquist frequency is removed before transmission, which increases the accuracy of the transmitted power average.

Referring now to FIG. 7, a droop diagram 700 of an ESS is shown according to an exemplary embodiment. In particular, the droop diagram 700 depicts various droop curve set points of an ESS that may be dynamically set or adjusted based on a received power average from a power source (e.g., a grid forming power source). The dynamic ESS droop curve set points allow for the ESS to provide support to the power sources (e.g., absorbing load via charging when the power sources are at or near minimum load requirements or providing power when the power sources are at or near maximum load capacities) and also absorbing transient events experienced on the power grid.

The droop diagram 700 has a y-axis 701 that indicates the output power of the ESS and an x-axis 702 that indicates sensed electrical parameters of power on the power grid (e.g., frequency and voltage). The droop diagram 700 includes an operating range 703. The operating range 703 indicates the potential power output reaction of the ESS relative to the electrical parameters of the grid. For example, for purposes of demonstration, a first curve 710, a second curve 711, and a third curve 712 within the operating range 703 are discussed in detail. The curves 710, 711, and 712 indicate how the ESS will react (e.g., output power or receive power from the power grid) in response to detecting that the frequency and/or voltage of the power grid are deviating from nominal values. It is to be appreciated that the curves 710, 711, and 712 are meant by way of example only and that there are a continuum of potential curves within the operating range. For additional reference, a top 780 of the operating range 703 indicates a maximum amount of power output (e.g., 100%) from the ESS to the power grid and a bottom 781 of the operating range 703 indicates a maximum amount of power consumption (e.g., −100%) of the ESS from the power grid.

The first curve 710 indicates a maximum charge droop state where the ESS is configured to charge (e.g., receive power from the grid) even if the frequency and/or voltage of the power grid are below nominal values. However, the ESS will output power if the frequency and voltage of the power grid falls below a lower threshold 790. The lower threshold may be minus 10% of the nominal frequency and voltage values.

The second curve 711 indicates a zero power droop state where the ESS is configured to charge (e.g., receive power from the grid) if the frequency and voltage of the power grid are above nominal values and output power to the power grid if the frequency and/or voltage of the power grid are below the nominal values. The nominal frequency and/or voltage may be set based on the particular application or location of the power grid.

The third curve 712 indicates a maximum discharge state where the ESS is configured to discharge (e.g., output power to the grid) even if the frequency and/or voltage of the power grid are above nominal values. However, the ESS will charge (e.g., receive power from the grid) if the frequency and/or voltage of the power grid are above an upper threshold 791. The lower threshold may be plus 10% of the nominal frequency and/or voltage values.

The ESS may dynamically choose which curve 710, 711, or 712 that the ESS will follow based on the power average received from the power source (e.g., grid-forming power source). For example, if the grid-forming power source has a low power average (e.g., indicating that the power source is not currently outputting a significant amount of power that may be close to violating a minimum load threshold of the grid-former power source), then the ESS may dynamically or automatically choose to follow the first curve 710 such that the ESS can charge and provide additional load. In another example, if the grid-forming power source has an median power average (e.g., indicating the power source is outputting a median amount of power relative to capacity), then the ESS may dynamically or automatically choose to follow the second curve 711 such that ESS does not receive or output power when the frequency and voltage are at nominal values yet is still available to support transient events. In yet another example, if the grid-forming power source has an high power average (e.g., indicating the power source is outputting a high amount of power relative to capacity), then the ESS may dynamically or automatically choose to follow the third curve 712 such that ESS is outputting a maximum amount of power when the frequency and voltage are at nominal values in an attempt to support the grid-forming power source (e.g., and thereby the other power sources since they are also iteratively working toward a nominal operating set point or balanced state).

The slope of the first, second, and third curves 710, 711, and 712 may be set or dynamically changed to be steep enough to achieve grid stability. The steepness of the curves may be dependent upon the particular power grid being implemented. For example, an application where the ESS is deployed in a system with expected large transient events, the steepness of the curves may be increased to ensure that the ESS reacts accordingly to the large transient events. In other embodiments, the curves 710, 711 and 712 may be nonlinear. In some embodiments, the ESS may receive a command from a supervisory controller or other device to set the curve that the ESS will follow. In some embodiments, the ESS may limit instantaneous power output based on the short-term damage curves of the system. For example, the ESS may limit the instantaneous power by changing the slow of the droop curve beyond the rating of the system (e.g., change the slope to zero or near zero beyond the rating of the system).

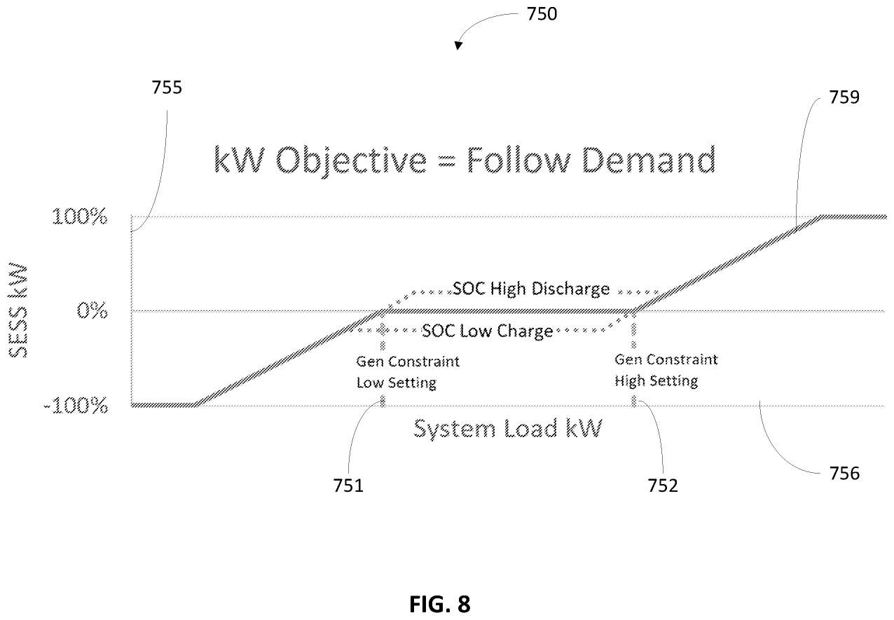

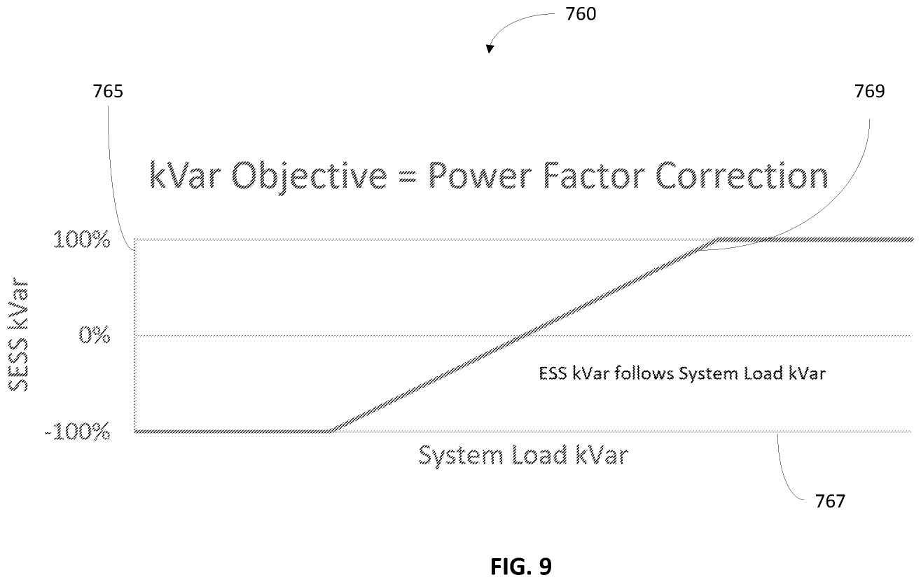

FIGS. 8 and 9 are referred to in tandem for purposes of demonstration. FIG. 8 depicts a droop curve 750 of an ESS according to a first objective as shown according to an exemplary embodiment. FIG. 9 depicts a droop curve 760 of an ESS according to a second objective as shown according to an exemplary embodiment. In some embodiments, objectives of the ESS may be set via a user input or command. For example, a user input or command may be transmitted to the ESS via a device (e.g., supervisory controller) via the network or input via a user interface on the ESS controller. The objectives may include multiple different settings for the kilo-watt (kW) output objective and/or the kilovolt-amperes reactive (kVar) output objective.

For example, the objectives for the kW output objective of the ESS may include a charge in accordance with a generator constraints setting, a max charge setting, a follow demand setting, a maximized discharge setting, and/or an output kW set point. The charge in accordance with a generator constraints setting may indicate to the ESS the goal of charging the ESS while maintaining a limit on the generator power output determined by an upper threshold (e.g., a pre-defined generator kW upper constraint set point). For example, in the charge in accordance with a generator constraints setting, the ESS may determine or access a droop curve that allows the ESS to charge when the power average of the power sources (e.g., grid former) is below the upper threshold (e.g., via consuming the difference). The max charge setting may indicate to the ESS to charge as fast as possible without overloading the power sources. For example, in the max charge setting, the ESS may determine a droop curve (e.g., droop curve 710) that designates the ESS to charge using all of the kW available from the power sources without overloading the power sources. The power average from the power sources may be used to determine the amount of kW available for charging. In the maximum discharge setting, the ESS may determine or access a droop curve (e.g., curve 712) that allows for the ESS to output as much power as possible up to a zero (e.g., or pre-defined lower generator load limit) generator load (e.g., which is indicated to the ESS by the power average). In the output kW set point setting, the ESS may maintain a desired or pre-defined kW output.

As an illustrative example, FIG. 8 depicts a droop curve graph 750 in the follow demand setting. The graph 750 includes a y-axis 755 that indicates a kW output of the ESS in the follow demand setting, an x-axis 756 that indicates a system load kW, and a droop curve 759. The system load kW may be indicated to the ESS via a received power average from the power sources (e.g., grid former) or determined via sensing at the output. In the follow demand setting the ESS may determine or access a droop curve 759 such that the ESS will limit the power of the power sources (e.g., determined by the ESS based on the power average) within a lower threshold 751 (e.g., a pre-defined generator kW lower constraint set point) and the upper threshold 752. If the power average exceeds the upper threshold 752 or is below the lower threshold 751, the ESS will attempt to provide or consume the difference in order to keep the power average of the power sources within the range of the lower and upper threshold. The shape of the droop curve 759 (e.g., droop curve on the graph 750) may be flattened out at +/−100% to limit output to safe levels regardless of bus fluctuations.

Further, the objectives for the kVar output objective of the ESS may include a power factor correction setting and/or an output kVar set point. In the output kVar set point, the ESS may maintain or attempt to maintain a desired pre-defined kVar output. Further, as an illustrative example, FIG. 9 depicts a droop curve graph 760 in the follow demand setting. The graph 760 includes a y-axis 765 that indicates a kVar output of the ESS in the power factor correction setting, an x-axis 766 that indicates a system load kVar, and a droop curve 769. In the power factor correction setting, the ESS may supply kVars to load to maintain or attempt to maintain a unity power factor for the power sources. Further, the ESS may limit a kVar output so not to exceed the kVar rating of the ESS (e.g., indicated by the flattened droop curve at the maximum and minimum). It is to be appreciated that the kW demand may take priority over the kVar demand or objective when the ESS is at upper constraints of the hardware ratings. In the output kVar set point, the ESS may maintain or attempt to maintain a desired pre-defined kVar output.

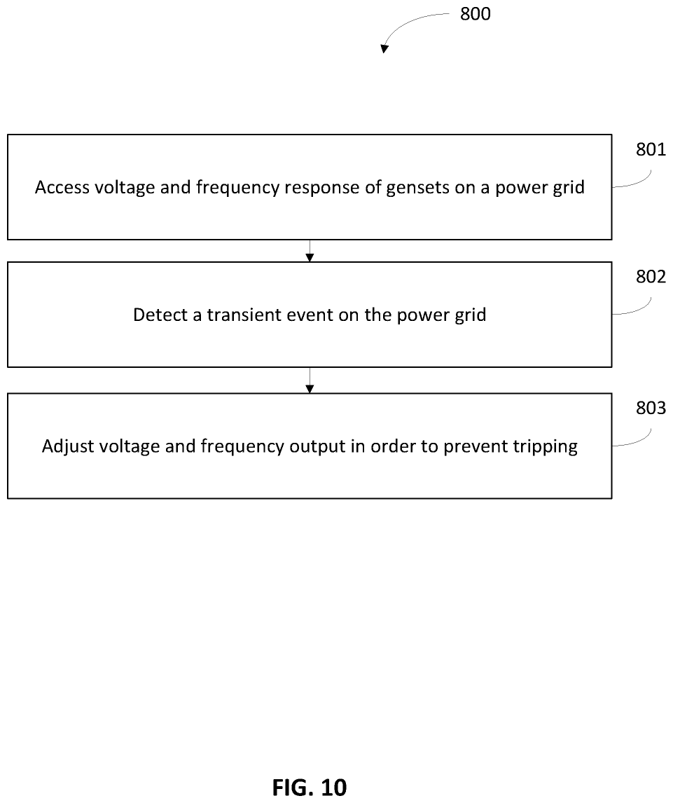

Referring now to FIG. 10, a flow diagram of a method 800 of voltage and hertz (V/Hz) control of an ESS is shown according to an exemplary embodiment. The method 800 describes a method of controlling the output electrical parameters (e.g., voltage and frequency) of the ESS in response to experiencing a transient event. In particular, a solid state inverter (e.g., as the inverters on an ESS) will output a frequency and voltage according to set parameters (e.g., nominal values of the power grid) within the controller. However, when a transient event occurs on a power grid (e.g., turning on of a large load), power sources on the power grid experience the increased load and slow down (e.g., thereby decreasing the output frequency and/or voltage of the power on the grid). As a result, the ESS reacts and outputs power at the nominal values of the power grid, which, if the load is too large, may cause the ESS to trip, fault, or otherwise disconnect (e.g., because the ESS is attempting to absorb the full load). The disconnection of the ESS during the transient event may cause other ESSs on the grid to also fail, trip, or disconnect, resulting in a cascading failure. Accordingly, the method 800 describes a method of dynamically and automatically reducing the output voltage and/or frequency of an ESS to mimic the reaction of the gensets to the transient event in order to prevent tripping during transient events. Further, a coordinated V/Hz response between the ESS and the power source may also reduce an amount of reactive power flow between the power sources and improve the overall response of the system.

The method 800 may be implemented in any of the power generation systems (e.g., power generation system 100, power generation system 200, and power generation system 300) described above. For the purposes of simplicity, the method 500 will be described below as it can be implemented in power generation system 300. However, this description is not meant to be narrowing and the method 400 could be similarly implemented in power generation system 200 and power generation system 100.

In some embodiments, the power generation system 300 includes a first energy storage system 302a coupled to a power grid 310 and coupled to a first controller 304a. The power generation system 300 may also include a second energy storage system 302b coupled to the power grid 310 and coupled to a second controller 304b. In some embodiments, the first and second controllers 304a and 304b may be configured to act independently. Specifically, neither the first or second controller may be designated as a “lead controller” or a “follower controller” in this embodiment. In such an embodiment, the first controller 304a and the second controller 304b can independently determine voltage and frequency measurements of their respective energy storage systems, determine that the power generation system 300 is experiencing a transient event based on the voltage and frequency measurements, and adjust the frequency and voltage of the output power of their respective energy storage systems to manage the transient event without tripping the power generation system 300.

In some embodiments, the first energy storage system 302a and the second energy storage system 302b are different types of energy storage systems with different power supply curves. In some embodiments, the transient event includes at least one of a load increase above a certain threshold, a load decrease below a certain threshold, a voltage droop below a certain level, a frequency increase above a certain threshold, and a frequency decrease below a certain threshold. In some embodiments, determining, by either the first controller 304a or the second controller 304b, that the power generation system 300 is experiencing the transient event can include: comparing, by either the first controller 304a or the second controller 304b, the voltage and frequency measurements to a nominal value, and in response to the voltage and frequency measurements deviating from the nominal value by a certain amount, determine, by either the first controller 304a or the second controller 304b, that the power generation system 300 is experiencing the transient event.

In some embodiments, determining, by either the first controller 304a or the second controller 304b, that the power generation system 300 is experiencing the transient event can include receiving communication from a supervisory controller that the transient event is occurring. In some embodiments, the first controller 304a and the second controller 304b can be configured to balance a load share among the plurality of inverters and one or more other power sources targeting the power target. In some embodiments, the one or more other power sources 302c-302d includes at least one of a genset, a fuel cell, a photovoltaic cell, or a wind turbine.

In operation 801, the ESS accesses voltage and frequency responses of power sources on a power grid. For example, the ESS may receive from a grid-forming power source the power capacity, power average, or information regarding a function of how a transient event may affect the grid-forming power source (e.g., or the system as a whole). In some embodiments, the voltage and frequency response of power sources on the power grid may be stored in a memory on the ESS. In some embodiments, the ESS may dynamically calculate or estimate a function of how a transient event may affect the voltage and/or frequency output of power sources on the power grid based on the power capacity, power average, or other information regarding the power sources.

In operation 802, the ESS may detect that a transient event on the power grid is occurring. For example, the ESS may detect that the frequency and voltage are deviating from nominal values. In some embodiments, the ESS may determine the extent of the transient event (e.g., the extremity of the transient event) based on the amount that the frequency and voltage are deviating from the nominal values. In some embodiments, the ESS may receive via a communication from another device such as a supervisory controller, that a large transient event is occurring or about to occur (e.g., an indication that a large load is about to be or is being connected to the grid). In response, for example, to prepare for a large load connection (e.g., a predefined size of the load), the ESS may load the power sources as much as possible or by a predefined amount based on the size of load (e.g., via outputting less electrical power or consuming power and thereby causing the power sources to increase power output to maintain grid stability) in order to avoid lag in the horsepower response of the power sources. Once the large load is connected, the ESS may detect that the large load has been connected (e.g., via detecting conditions on the power grid) or receive an indication from a device (e.g., such as the supervisory controller) and begin to increase the amount of power output from the ESS to absorb the transient event caused from the large load connection. For example, the ESS may automatically switch from charging to discharging or increase a power discharge amount by an amount that will allow for the large load to be connected such that the power source loads (e.g., increased power source loads) remain relatively unchanged. For example, the exact amount of power output change may be based on the power output capabilities of the ESS and the predefined (e.g., received indication) size of the large load. In this way, the large transient event (e.g., an addition of a large load) can be handled proactively by the power sources on the grid, which improves grid stability.

In operation 803, the ESS may adjust the frequency and voltage of the output power of the ESS. For example, the ESS may adjust the frequency and voltage of the output power to mimic the frequency and voltage response of the power sources. In this way, the ESS may provide necessary support to the power grid during the transient event while reducing reactive power flow between the sources and also reducing the potential of a fault that would cause the ESS to disconnect. The ESS may adjust the frequency and voltage of the output power according to the function estimated, determined, or accessed in operation 501. In some embodiments, the ESS may not follow a function, rather the ESS may match the detected frequency and voltage on the power grid and output maximum power while continuously (e.g., or iteratively) adjusting the output frequency and voltage of the ESS to match the current frequency and voltage output of the power grid (e.g., which should be returning to nominal as the power source has time to react and catch up). In some embodiments, the frequency and voltage of the output of the ESS may have a minimum threshold (e.g., −10%) that the ESS will not fall below (e.g., or try to match below that minimum threshold) regardless of the detected frequency and voltage on the power grid.

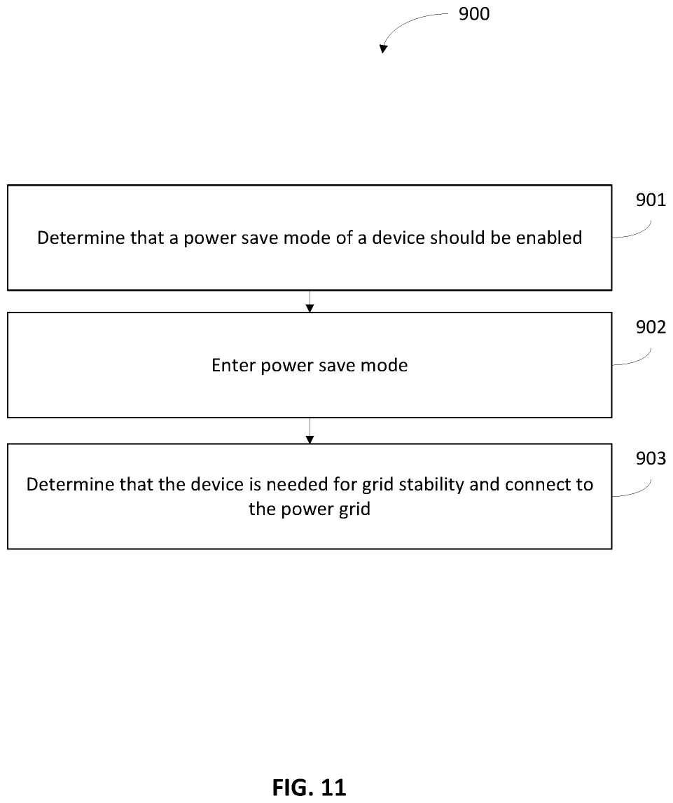

Referring now to FIG. 11, a flow diagram of a method 900 in an ESS power save mode is shown according to an exemplary embodiment. That is, in some embodiments, the ESS may include a power save mode. The power save mode may be a mode during operation (e.g., while connected to the power grid) where the ESS is available, but gated such that the ESS is not outputting or receiving power. That is, in the power save mode, the ESS may be connected to and monitoring electrical parameters on the grid (e.g., via a bus), but dormant to avoid switching losses.

In operation 901, the ESS determines that the power save mode should be started. The power save mode may automatically be entered by the ESS when the ESS detects for a predefined amount of time that no power is demanded from the ESS and no power is needed to charge the ESS. In some embodiments, the ESS may determine that the power save mode should be started in response to receiving a manual input or a command from a user or computing device of a user. In some embodiments, the ESS may determine that other power sources are connected to the power grid and the power demand on the ESS below a lower threshold (e.g., a pre-defined value) or in a predefined lower range (e.g., 0-20% power output of capacity) and, in response, determine that the ESS can stop outputting power and enter the power save mode. For example, the ESS may determine that other power sources are connected to the power grid via receiving a power average (e.g., a filtered power average from a grid forming power source) from the other power sources.

In operation 902, the ESS enters the power save mode in response to the determination made in operation 601. The power save mode may gate the ESS from the power grid, which may reduce parasitic power consumption. In some embodiments, the ESS may cause a switch to open such that the ESS is electrically disconnected from the power grid. However, while in the power save mode, the ESS may monitor the frequency and voltage of the electrical power on the power grid.

In operation 903, the ESS may reconnect to the grid based, for example, at least in part on the stability of the grid. For example, the ESS may monitor the frequency and voltage of the electrical power on the power grid for a deviation from a nominal range (e.g., +/−3% from nominal values). In response to detecting that the frequency and/or voltage has deviated from the nominal range, the ESS may gate back onto the power grid until grid stability is restored and ESS power demand has subsided (e.g., the frequency and voltage of the power grid return to the nominal range). For example, the ESS may cause a switch to close that reconnects the ESS to the power grid in operation 903 such that the ESS can provide grid stability via outputting or receiving power.

Referring now to FIG. 12, a graph 1000 of a one-way power source is depicted. For example, the one way power source may include a solar power source, a wind power source, or other renewable power source that is configured to connect to the power grid and output power to the grid. In other words, the one-way power source may only be configured to output power to the power grid and not to receive power from the power grid.

The graph 1000 includes a y-axis 1001 that indicates a power output level of the one-way power source (e.g., in % kW and % kVar) and an x-axis 1002 that indicates the values of the electrical power on the power grid (e.g., the frequency and/or voltage of the electrical power). The graph 1000 also includes a droop curve 1003 that indicates the response of power output level of the one-way power source relative to the detected, monitored, or determined values of the electrical power on the power grid. That is, the droop curve 1003 may be set or dynamically determined within a controller of the one-way power source such that the one-way power source is configured to maximize their power output as long as the electrical power is being consumed by an ESS on the power grid or load.

For example, when the one-way power source determines or detects that the frequency and/or voltage on the power grid are at nominal values (e.g., 60 Hz and/or 240V), the one-way power source is configured to output the maximum amount (e.g., or be momentarily overloaded, which may support grid stability) of power possible to the power grid (e.g., 100%). In this way, when the power grid is operationally steady (e.g., operating with the electrical power at the nominal values) the one-way power source (e.g., renewable power source) is outputting a maximum amount of renewable power to the power grid, which ensures that the grid is supported by as much renewable energy as possible. The droop curve 1003 indicates that the one-way power source will curtail the output power as the frequency or voltage exceeds the nominal values, which allows for the one-way power source to react to grid transients such that the grid stability is maintained. It is to be appreciated that the slope of the droop curve 1003 or the exact function of the droop curve 1003 may be set or dynamically adjusted to ensure that grid stability is maintained. For example, the slope of the droop curve 1003 beyond the nominal values may be increased in particular implementations (e.g., implementations having large expected transients) or reduced in other implementations. After a transient event, the one-way power source may iteratively or continuously adjust the power output back to the maximum (e.g., 100%) in order to ensure that the maximum amount of renewable power is being used, which increases the efficiency of the power grid. In this way, the one-way power source may actively push (e.g., output more power) power onto the power grid such that the other power sources can reduce the respective output powers and maximize the efficiency of the grid. For example, the power sources (e.g., one way power source and/or power sources) can implement a local limited reverse power flow control algorithm to accommodate for the slower network (e.g., due to limited bandwidth) with higher latencies and actively work toward a nominal balanced steady state without communication over the network.

The one way power source may also have objectives defined by a user input or via a supervisory controller. For example, the one way power source may have kW objectives of maximum export and/or output kW set points. Moreover, the one way power source may have kVar objectives of power factor correction or an output kVar set point setting. The one way power source, with the maximum export kW setting may target a 100% power output. However, as discussed below, may not export 100% power output if the power sources are below a lower load limit or at 0% power output. The one way power source, with the output kW setting, may output a predefined magnitude of kW. Similar, the one way power source, with the output kVar setting may output or attempt to output a predefined amount of magnitude of kVar. Further, the one way power source, with the power factor correction setting, may output as much kVars as possible in attempt to maintain a unity power factor for the power sources.

As another example, the one-way power source may determine a power average, filter the power average to a suitable network rate (e.g., as explained in reference to FIGS. 4 and 5) and transmit the power average to the other power sources. The other power sources may use the power average of the one-way power source to curtail power output (e.g., if the one-way power average indicates that the one-way power source is not outputting a power average above 50%) such that the one-way power source will respond to the curtailed power (e.g., sensed or determined by the one-way power source as a drop of frequency and/or voltage on the grid) by increasing the power output of the one-way power source to a maximum amount, thereby again maximizing the efficiency of the power grid.

As another example, the one-way power source may receive the power average (e.g., filtered power average) from one or more of the other power sources (e.g., from the grid-forming power source) and use the power average to maximize operating conditions. For example, the power average may indicate that the grid-forming power source is at or near a lower threshold that indicated a minimum load requirement of the power source or that the power source is not outputting any power (e.g., a 0 power average). In response, the one-way power source (e.g., inverter of the solar or wind power source) may curtail the power output of the solar or wind power source such as to prevent reverse power flow to the power sources. For example, the one-way power source may receive the power average, determine that the power average is below a threshold (e.g., a predefined threshold), and in response, lower the power output of the one-way power source such that the power sources are not receiving reverse power flow or are above a minimum load threshold. The one-way power source may iteratively curtail the power output in response to each power average received or may curtail the power output by an amount that is related to the amount that the power average is below the threshold. In this way, the one-way power source may use the power average to maximize operating conditions and longevity of the power sources or other power sources.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system. No claim element herein is to be construed under the provisions of 35 U.S.C. § 112, sixth paragraph, unless the element is expressly recited using the phrase “means for.” Furthermore, no element, component or method step in the present disclosure is intended to be dedicated to the public, regardless of whether the element, component or method step is explicitly recited in the claims.

As noted above, embodiments within the scope of the present disclosure include program products comprising machine-readable storage media for carrying or having machine-executable instructions or data structures stored thereon. Such machine-readable storage media can be any available media that can be accessed by a computer or other machine with a processor. By way of example, such machine-readable storage media can include RAM, ROM, EPROM, EEPROM, CD ROM or other optical disk storage, magnetic disk storage or other magnetic storage devices, or any other medium which can be used to carry or store desired program code in the form of machine-executable instructions or data structures and which can be accessed by a computer or other machine with a processor. Combinations of the above are also included within the scope of machine-readable storage media. Machine-executable instructions include, for example, instructions and data which cause a computing device or machine to perform a certain function or group of functions. Machine or computer-readable storage media, as referenced herein, do not include transitory media (i.e., signals in space).

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a computing device that includes, for example, a processing unit, a system memory, and a system bus that couples various system components including the system memory to the processing unit. The system memory may include read only memory (ROM) and random access memory (RAM) or other non-transitory storage medium. The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A method for operating a power generation system, the method comprising:
determining whether a grid-forming power source is present;
assigning a lead inverter among a plurality of inverters, wherein the lead inverter comprises a lead controller;
determining, by the lead controller, a power target to achieve a power objective based on information received from the grid-forming power source; and
causing the power target to be implemented in the plurality of inverters.

2. The method of claim 1, further comprising assigning one of the plurality of inverters to be the grid-forming power source if the lead controller determines that the grid-forming power source is not present.

3. The method of claim 1, wherein the lead controller determines the power target to either send power to a grid or receive power from the grid to accomplish the power objective of the grid.

4. The method of claim 3, further comprising:
assigning one or more of the plurality of inverters as follower inverters, wherein each of the follower inverters includes a follower controller; and
balancing, by each follower controller, a load share between the plurality of inverters and one or more other power sources targeting the power target.

5. The method of claim 4, wherein implementing the power target in the plurality of inverters further comprises:
transmitting, by the lead inverter over a network, the power target to one or more of the plurality of inverters;
receiving, at each of the follower inverters, via the network, the power target; and
adjusting, at the follower inverters, the power output of the follower inverters such that a power output of the follower inverters is adjusted toward the power target.

6. The method of claim 5, wherein adjusting the power output of the follower inverters comprises increasing the power output of the follower inverters in response to determining that the power output of the follower inverters is lower than the power target.

7. The method of claim 5, wherein adjusting the power output of the follower inverters comprises decreasing the power output of the follower inverters in response to determining that the power output of the follower inverters is higher than the power target.

8. A power generation system comprising:
a first battery coupled to a first inverter among a plurality of inverters, the first inverter comprising a lead controller;
a second battery coupled to a second inverter among the plurality of inverters, the second inverter comprising a follower controller;
wherein the lead controller is configured to:
determine whether a grid forming power source is present;
determine a power target to achieve a power objective based on information received from the grid forming power source; and
transmit, via a network, the power target to the second inverter.

9. The power generation system of claim 8, wherein the follower controller is configured to:
receive the power target; and
adjust the power output of the second battery such that a filtered power average of the second battery is adjusted toward the filtered power average of the first battery.

10. The power generation system of claim 9, wherein adjusting, by the follower controller, the power output of the second battery comprises increasing the power output of the second battery in response to determining that the filtered power average of the second battery is lower than the filtered power average of the first battery.

11. The power generation system of claim 9, wherein adjusting, by the follower controller, the power output of the second battery comprises decreasing the power output of the second battery in response to determining that a power average percentage of the second battery is higher than the power average percentage of the first battery.

12. The power generation system of claim 8, wherein the lead controller is further configured to assign one of the plurality of inverters to be the grid-forming power source if the lead controller determines that the grid-forming power source is not present.

13. The power generation system of claim 8, wherein the lead controller determines the power target to either send power to a grid or receive power from the grid to accomplish the power objective of the grid.

14. The power generation system of claim 8, wherein the follower controller is further configured to balance a load share among the plurality of inverters and one or more other power sources targeting the power target, wherein the one or more other power sources includes at least one of a genset, a fuel cell, a photovoltaic cell, or a wind turbine.

15. A power generation system comprising:
a first energy storage system coupled to a power grid and coupled to a first controller; and
a second energy storage system coupled to the power grid and coupled to a second controller;
wherein the first controller and the second controller are independently configured to:
determine voltage and frequency measurements of their respective energy storage systems;
determine that the power generation system is experiencing a transient event based on the voltage and frequency measurements; and
adjust the frequency and voltage of the output power of their respective energy storage systems to manage the transient event without tripping the power generation system.

16. The power generation system of claim 15, wherein the first energy storage system and the second energy storage system are different types of energy storage systems with different power supply curves.

17. The power generation system of claim 15, wherein the transient event includes at least one of a load increase above a certain threshold, a load decrease below a certain threshold, a voltage droop below a certain level, a frequency increase above a certain threshold, and a frequency decrease below a certain threshold.

18. The power generation system of claim 15, wherein determining, by either the first controller or the second controller, that the power generation system is experiencing the transient event includes:
comparing, by either the first controller or the second controller, the voltage and frequency measurements to a nominal value; and
in response to the voltage and frequency measurements deviating from the nominal value by a certain amount, determine, by either the first controller or the second controller, that the power generation system is experiencing the transient event.

19. The power generation system of claim 15, wherein determining, by either the first controller or the second controller, that the power generation system is experiencing the transient event includes receiving communication from a supervisory controller that the transient event is occurring.

20. The power generation system of claim 15, wherein the first controller and the second controller are further configured to balance a load share among the plurality of inverters and one or more other power sources targeting the power target, wherein the one or more other power sources include at least one of a genset, a fuel cell, a photovoltaic cell, or a wind turbine.
